(19) United States
(12) Patent Application Publication
(10) Pub. No.: US 2020/0147526 A1
(43) Pub. Date: May 14, 2020

(54) Faucet-Mounted Beverage Filter

(71) Applicant: Kristjan Olafsson, Miami Beach, FL (US)

(72) Inventor: Kristjan Olafsson, Miami Beach, FL (US)

(73) Assignee: Helix Spirits LLC, Miami Beach, FL (US)

(21) Appl. No.: 16/683,657

(22) Filed: Nov. 14, 2019

Related U.S. Application Data
(60) Provisional application No. 62/767,163, filed on Nov. 14, 2018.

(51) Int. Cl. B01D 29/23; A23L 2/72; B67D 1/00

(52) U.S. Cl. CPC B01D 29/23; A23L 2/72; B67D 2210/0001; A23V 2002/00; B67D 1/0042

(57) ABSTRACT

A beverage filter includes a central base mount that is mounted on a faucet tower and through which liquid from a liquid source flows. A cylindrical filter is mounted on the base mount and is configured to receive the liquid therefrom. A cylindrical transparent sight glass is disposed around the cylindrical filter. A top cap is mounted on the sight glass so that the top cap, the base mount, the filter and the sight glass define a cylindrical void that is viewable through the sight glass and into which liquid passes after it has been filtered. A faucet is in fluid communication with the cylindrical void through the base mount and is configured to pour liquid after it has been filtered.

### CROSS-REFERENCE TO RELATED APPLICATION(S)

This application claims the benefit of U.S. Provisional Patent Application Ser. No. 62/767,163, filed Nov. 14, 2018, the entirety of which is hereby incorporated herein by reference.

### BACKGROUND OF THE INVENTION

### 1. Field of the Invention

The present invention relates to filters and, more specifically to a filter for beverages.

### SUMMARY OF THE INVENTION

In one representative embodiment, the invention is a beverage filter that includes a central base mount that is mounted on a faucet tower and through which liquid from a liquid source flows. A cylindrical filter is mounted on the base mount and is configured to receive the liquid therefrom. A cylindrical transparent sight glass is disposed around the cylindrical filter. A top cap is mounted on the sight glass so that the top cap, the base mount, the filter and the sight glass define a cylindrical void that is viewable through the sight glass and into which liquid passes after it has been filtered. A faucet is in fluid communication with the cylindrical void through the base mount and is configured to pour liquid after it has been filtered.

### BRIEF DESCRIPTION OF THE FIGURES OF THE DRAWINGS

FIG. 1 is a schematic diagram showing one embodiment of a beverage filter.

FIG. 2 is a schematic diagram showing a the embodiment of a beverage filter shown in FIG. 1.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

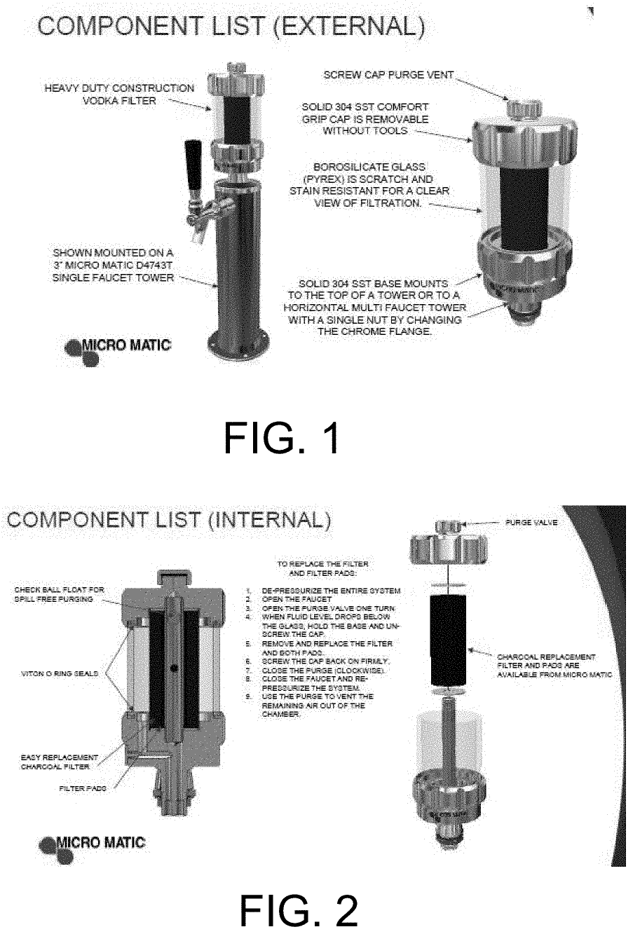

As shown in FIGS. 1 and 2, one embodiment of a beverage filter can be mounted on a tap, such as a bar tap, to allow patrons to view filtering of the beverage as it is being poured. It includes a transparent or translucent sight glass (which could include a glass or plastic material) surrounding a cylindrical filter (which could include a charcoal filter, a paper filter, a plastic filter, etc. When pouring, the liquid comes up through a center stem, flows out through the filter into the space defined between the filter and the sight glass, then it flows down through a base mount and through a faucet into a glass.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112(f) unless the words “means for” or “step for” are explicitly used in the particular claim. The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A beverage filter, comprising:
(a) a central base mount that is mounted on a faucet tower through which liquid from a liquid source flows;
(b) a cylindrical filter mounted on the base mount and configured to receive the liquid therefrom;
(c) a cylindrical transparent sight glass disposed around the cylindrical filter;
(d) a top cap mounted on the sight glass so that the top cap, the base mount, the filter and the sight glass define a cylindrical void that is viewable through the sight glass and into which liquid passes after it has been filtered; and
(e) a faucet in fluid communication with the cylindrical void through the base mount and configured to pour liquid after it has been filtered.
